(19) United States
(12) Patent Application Publication
(10) Pub. No.: US 2026/0223264 A1
(43) Pub. Date: Jul. 30, 2026

(54) POWER FACTOR CORRECTION CIRCUIT FOR MULTIPLE-WAY LAMP AND MULTIPLE-WAY LAMP INCLUDING THE SAME

(71) Applicant: SAVANT TECHNOLOGIES LLC, East Cleveland, OH (US)

(72) Inventors: Yimin ZHU, Shanghai (CN); Jie GAO, Shanghai (CN); Bin LI, Shanghai (CN)

(73) Assignee: SAVANT TECHNOLOGIES LLC, East Cleveland, OH (US)

(21) Appl. No.: 19/430,542

(22) Filed: Dec. 23, 2025

(30) Foreign Application Priority Data
Jan. 27, 2025 (CN) 2025201776028

(51) Int. Cl. H05B 45/355; H05B 45/10; H05B 45/345

(52) U.S. Cl. CPC H05B 45/355; H05B 45/10; H05B 45/345

(57) ABSTRACT

Provided is a power factor correction circuit for a multiple-way lamp and a multiple-way lamp that includes branches, each having a capacitor element, a constant-current driver chip and a lamp load, and a positive electrode of the lamp load is directly or indirectly connected to a power input end, a first end of the capacitor element is connected to the power input end, and a second end of the capacitor element is grounded, the constant-current driver chip is connected in series between the ground and a negative electrode of the lamp load or between the power input end and the positive electrode of the lamp load, and the power factor correction circuit is located in a branch and has a resistor element arranged between the power input end and the first end of the capacitor element or between the second end of the capacitor element and the ground.

### CROSS-REFERENCE TO RELATED APPLICATIONS

This application claims priority to Chinese Patent Application Serial Number 2025201776028, filed January 27, 2025, which is herein incorporated by reference.

### TECHNICAL FIELD

The present application relates to a multiple-way lamp, and in particular, to a power factor correction circuit for a multiple-way lamp and a multiple-way lamp including the same.

### BACKGROUND

A multiple-way lamp is an indispensable constituent part in modern lighting systems, and is particularly suitable for scenarios requiring diversified lighting effects and flexibility, such as commercial spaces, residential areas, public places, and outdoor lighting. By a plurality of independent branches, the multiple-way lamp can provide light with different brightness, thereby satisfying various lighting requirements from low illuminance to high illuminance.

Power factor is one of important indicators for measuring the energy efficiency of a lighting device. Along with ever-increasing global emphasis on energy conservation and environmental protection, the lighting device is expected to have a high power factor, e.g., above 0.7. A high power factor means efficient use of electricity, and reduces the reactive power demand of a power grid, thereby reducing the overall energy consumption and environmental pollution.

To meet such a high standard, designs of current multiple-way lamps often employ complex active power factor correction circuits. An active power factor correction circuit generally comprises components such as a control chip and a power switch. Although the active power factor correction circuit can improve the power factor of a multiple-way lamp, it greatly increases the manufacturing cost of the lamp. In addition, the complexity of the active power factor correction circuit may introduce additional maintenance and failure risks, limiting the large-scale deployment and application of multiple-way lamps.

In view of this, a new circuit design, which aims to increase the overall power factor of a multiple-way lamp (in particular when a plurality of branches are all conducted) in an economical and efficient manner, is desired.

### SUMMARY OF THE INVENTION

The present application is proposed in view of the problems above. A main object of the present application is to provide a solution for the power factor of a multiple-way lamp, which can not only meet or exceed the power factor requirement of industry standards, but also keep low cost and simple structure of the multiple-way lamp, thereby facilitating the application thereof in wider scenarios, so as to solve the technical problem in the prior art that it is difficult for a multiple-way lamp to achieve a high power factor while maintaining low cost and a simple structure.

In order to achieve the described object, according to one aspect of the present application, provided is a power factor correction circuit for a multiple-way lamp, the multiple-way lamp comprises a plurality of branches, each branch comprising a capacitor element, a constant-current driver chip and at least one lamp load, wherein the at least one lamp load has a positive electrode and a negative electrode, the positive electrode of the at least one lamp load is directly or indirectly connected to a power input end; the capacitor element comprises a first end and a second end, the first end of the capacitor element is connected to the power input end, and the second end of the capacitor element is grounded; the constant-current driver chip is connected in series between the ground and the negative electrode of the at least one lamp load or between the power input end and the positive electrode of the at least one lamp load; the power factor correction circuit is located in at least one branch of the plurality of branches; and the power factor correction circuit comprises: at least one resistor element, wherein each resistor element is located in a corresponding branch of the at least one branch, and the resistor element is arranged between the power input end and the first end of the capacitor element or between the second end of the capacitor element and the ground.

In this way, a power factor correction circuit for a multiple-way lamp is provided, in which by connecting a resistor element in series on either side of the capacitor element of at least one branch, the duration of a charging current when charging the capacitor element in the at least one branch is prolonged, so that the total power factor of the multiple-way lamp can be increased, in particular when the at least one branch is conducted, thereby increasing the electrical energy utilization rate of the circuit without increasing additional costs. In addition, the power factor correction circuit comprising the at least one resistor element has low cost and a simple structure.

Further, according to an embodiment of the present application, the number of lamp loads in the plurality of branches differ from one another.

In this way, as the number of lamp loads in the plurality of branches differ from one another, when different branches are conducted, different brightness of the multiple-way lamp can be achieved, so that the multiple-way lamp with multiple levels of brightness can be achieved. Then in combination with the power factor correction circuit, the power factor of the multiple-way lamp in some or even all levels can be increased.

Further, according to an embodiment of the present application, the power factor correction circuit further comprises: at least one diode, wherein each diode is located in a corresponding branch of the at least one branch and is connected in parallel with the resistor element of the branch, and an anode of the diode is located at an upstream position in a discharge path of the capacitor element relative to a cathode of the diode.

In this way, by using the diode connected in parallel with the resistor element, and by using the forward conduction characteristic of the diode, when discharged, the capacitor element can be discharged via the diode rather than via the resistor element. Thus, power loss caused by discharging of the capacitor element via the resistor element can be reduced, and the energy use efficiency of the circuit can be increased, and the simplicity and low-cost characteristics of the circuit can be also maintained.

Further, according to an embodiment of the present application, for any resistor element of the at least one resistor element, when the resistor element is arranged between the power input end and the first end of the capacitor element, the anode of the diode connected in parallel with the resistor element is connected to the first end of the capacitor element, and the cathode of the diode is connected to the power input end.

In this way, when the resistor element is arranged between the power input end and the first end of the capacitor element, by connecting the anode of the diode to the first end of the capacitor element, the anode of the diode is located at the upstream position in the discharge path of the capacitor element relative to the cathode.

Further, according to an embodiment of the present application, for any resistor element of the at least one resistor element, when the resistor element is arranged between the second end of the capacitor element and the ground, the anode of the diode connected in parallel with the resistor element is connected to the ground, and the cathode of the diode is connected to the second end of the capacitor element.

In this way, when the resistor element is arranged between the second end of the capacitor element and the ground, by connecting the anode of the diode to the ground, the anode of the diode is located at the upstream position in the discharge path of the capacitor element relative to the cathode.

Further, according to an embodiment of the present application, the at least one resistor element only comprises one resistor element, and the resistor element is located in a branch, where the number of lamp loads is the greatest, among the plurality of branches.

In the multiple-way lamp, compared with a low-load branch, a high-load branch has a greater effect on the power factor. In this way, by only applying the power factor correction circuit in a high-load branch, a larger increase of power factor can be achieved at a lower cost.

Further, according to an embodiment of the present application, each resistor element of the at least one resistor element comprises a plurality of resistors connected in parallel or in series.

In this way, the flexibility of the power factor correction circuit is expanded, so that the circuit can be adjusted in different conditions to achieve an optimal power factor. The design flexibility also facilitates cost control and performance optimization in the production and manufacture of the multiple-way lamp.

According to another aspect of the present application, provided is a multiple-way lamp, comprising: the power factor correction circuit for a multiple-way lamp as described above; and a plurality of branches, each branch comprising a capacitor element, a constant-current driver chip and at least one lamp load, wherein the at least one lamp load has a positive electrode and a negative electrode, the positive electrode of the at least one lamp load is directly or indirectly connected to a power input end; the capacitor element comprises a first end and a second end, the first end of the capacitor element is connected to the power input end, and the second end of the capacitor element is grounded; the constant-current driver chip is connected in series between the ground and the negative electrode of the at least one lamp load or between the power input end and the positive electrode of the at least one lamp load; wherein at least one resistor element of the power factor correction circuit is located in at least one branch of the plurality of branches, respectively.

In this way, a multiple-way lamp is provided. Compared with the prior art, such a multiple-way lamp can maintain a high power factor and reduce power consumption in cases where the plurality of branches are all conducted; and the multiple-way lamp has a low cost, a simple structure, and is easy to be applied on large scale.

Further, according to an embodiment of the present application, for any branch among the plurality of branches, the negative electrode of the at least one lamp load is connected to an output terminal of the constant-current driver chip, and a grounding terminal of the constant-current driver chip is connected to the ground.

In this way, the constant-current driver chip being connected in series between the ground and the negative electrode of the at least one lamp load can be achieved.

Further, according to an embodiment of the present application, for any branch among the plurality of branches, a power input terminal of the constant-current driver chip is connected to the power input end, and an output terminal of the constant-current driver chip is connected to the positive electrode of the at least one lamp load.

In this way, the constant-current driver chip being connected in series between the power input end and the positive electrode of the at least one lamp load can be achieved.

Embodiments of the present application provide a power factor correction circuit for a multiple-way lamp, wherein the multiple-way lamp comprises a plurality of branches, each branch comprising a capacitor element, a constant-current driver chip and at least one lamp load, wherein the at least one lamp load has a positive electrode and a negative electrode, the positive electrode of the at least one lamp load is directly or indirectly connected to a power input end; the capacitor element comprises a first end and a second end, the first end of the capacitor element is connected to the power input end, and the second end of the capacitor element is grounded; the constant-current driver chip is connected in series between the ground and the negative electrode of the at least one lamp load or between the power input end and the positive electrode of the at least one lamp load; the power factor correction circuit is located in at least one branch of the plurality of branches; and the power factor correction circuit comprises: at least one resistor element, wherein each resistor element is located in a corresponding branch of the at least one branch, and the resistor element is arranged between the power input end and the first end of the capacitor element or between the second end of the capacitor element and the ground, so as to solve the technical problem in the prior art that it is difficult for a multiple-way lamp to achieve a high power factor while maintaining low cost and a simple structure, thereby achieving the technical effect of providing a multiple-way lamp having a high power factor, while maintaining a simple structure and low cost.

### BRIEF DESCRIPTION OF THE DRAWINGS

The drawings of the description, constituting a part of the present application, are used for providing further understanding of the present application, and the illustrative embodiments of the present application and illustrations thereof are used to explain the present application, rather than constitute inappropriate limitation on the present application. In the drawings:

FIG. 1 is a schematic circuit diagram of a power factor correction circuit for a multiple-way lamp and a multiple-way lamp including the power factor correction circuit according to a first embodiment of the present application;

FIG. 2 is another schematic circuit diagram of a power factor correction circuit for a multiple-way lamp and a multiple-way lamp including the power factor correction circuit according to the first embodiment of the present application;

FIG. 3 is a schematic circuit diagram of a power factor correction circuit for a multiple-way lamp and a multiple-way lamp including the power factor correction circuit according to a second embodiment of the present application;

FIG. 4 is a schematic circuit diagram of a multiple-way lamp according to a third embodiment of the present application; and

FIG. 5 is a schematic circuit diagram of a power factor correction circuit for a multiple-way lamp and a multiple-way lamp including the power factor correction circuit according to a fourth embodiment of the present application.

### DETAILED DESCRIPTION

It is to be noted that embodiments in the present application and features in the embodiments may be combined with one another without conflicts. Hereinafter, the present application is described in detail with reference to the accompanying drawings and in conjunction with the embodiments.

It is to be noted that unless otherwise indicated, all technical and scientific terms used in the present application have the same meanings as those commonly understood by a person of ordinary skill in the art to which the present application belongs.

In the present application, unless specified to the contrary, directional terms such as "upper, lower, top and bottom" are generally used regarding the directions shown in the figures, or for the components themselves in vertical, perpendicular or gravity directions; likewise, for ease of understanding and description, "internal, external" refer to internal and external relative to the outline of each component itself, but the described directional terms are not used to limit the present application.

An object of the present application is to provide a power factor correction circuit for a multiple-way lamp and a multiple-way lamp including the power factor correction circuit, which can increase the total power factor of the multiple-way lamp, while maintaining a simple structure and low cost of the multiple-way lamp.

To this end, the present application provides a power factor correction circuit for a multiple-way lamp; the multiple-way lamp comprises a plurality of branches, each branch comprising a capacitor element, a constant-current driver chip and at least one lamp load, wherein the at least one lamp load has a positive electrode and a negative electrode, the positive electrode of the at least one lamp load is directly or indirectly connected to a power input end; the capacitor element comprises a first end and a second end, the first end of the capacitor element is connected to the power input end, and the second end of the capacitor element is grounded; the constant-current driver chip is connected in series between the ground and the negative electrode of the at least one lamp load or between the power input end and the positive electrode of the at least one lamp load; the power factor correction circuit is located in at least one branch of the plurality of branches; and the power factor correction circuit comprises: at least one resistor element, wherein each resistor element is located in a corresponding branch of the at least one branch, and the resistor element is arranged between the power input end and the first end of the capacitor element or between the second end of the capacitor element and the ground.

In the present application, by providing the resistor element in each branch of the at least one branch, the duration of the charging current of the capacitor element can be prolonged, thereby increasing the power factor (PF) of the circuit. The principle of increasing the power factor is explained below:

In each branch of the multiple-way lamp, the capacitor element is charged during a positive half cycle of each power supply voltage. In conventional cases without any resistor elements, the charging current of the capacitor element will rise rapidly and reach a maximum value near a voltage peak value, and then drop rapidly as the voltage drops, and at this time, the charging time is short, and both the rise and drop of a current waveform are sharp.

In the case of introducing a resistor element connected in series with the capacitor element, the resistor element increases the impedance of the circuit in the current rising process, so that the speed of current increase slows down, prolonging the time for the current to reach a peak value. Also, when the voltage drops, the resistor element slows down the speed of current reduction, prolonging the time for the current to drop from the peak value to zero, thereby prolonging the duration of the charging current of the capacitor element.

The increase of the power factor is closely related to the fitting degree of a current waveform and a voltage waveform. When the duration of the charging current of the capacitor element becomes longer and a charging current waveform is smoother, the phase difference between charging current waveform and voltage waveform is decreased. Such decrease in phase difference means an increase in the ratio of active power (actually consumed power) to apparent power (absolute value of product of voltage and current) in the circuit, and the power factor is defined as the ratio of the active power to the apparent power in the circuit, and thus the power factor of the circuit is increased.

Thus, the present application can increase the total power factor of the multiple-way lamp, and particularly the total power factor when all the branches of the multiple-way lamp are conducted, by using the power factor correction circuit with a simple structure and a low cost,.

In the present application, the multiple-way lamp may comprise two or more branches. In an exemplary embodiment, the number of resistor elements of the at least one resistor element may be one, and further, the one resistor element may be located in one branch, where the number of lamp loads is the greatest, among the plurality of branches of the multiple-way lamp. This is due to considering that in the plurality of branches of the multiple-way lamp, compared with a low-load branch, a high-load branch has a greater effect on the power factor. Therefore, by only applying the power factor correction circuit in a high-load branch instead of applying the power factor correction circuit in a low-load branch, a large increase of power factor can be achieved at a low cost.

Alternatively, the number of at least one resistor element may be equal to the number of branches in the multiple-way lamp, and each resistor element may be located in a corresponding branch. Alternatively, the number of at least one resistor element may be greater than one and less than the number of the branches, and the at least one resistor element may be respectively located in any at least one branch among the plurality of branches. Preferably, the at least one resistor element may be respectively located in at least one branch with a larger number of lamp loads among the plurality of branches (for example, at least one preceding branch among the plurality of branches arranged in a descending order of the number of lamps loads).

Further, in the present application, each resistor element may comprise a plurality of resistors connected in parallel or in series. In this way, the flexibility of the composition of the resistor element can be improved, and cost control and performance optimization can be achieved in the production and manufacture of the multiple-way lamp. For example, each resistor element may comprise a plurality of resistors connected in parallel or in series and having the same resistance value. The resistance value of the resistor element may be changed simply by changing the number of resistors, so as to meet the circuit requirement. Alternatively, the resistance values of the plurality of resistors connected in parallel or in series, which are included in one resistor element, may be different from each other, or partially the same and partially different.

Further, in the present application, the power factor correction circuit can further comprise a diode connected in parallel with each resistor element.

The diode in the present application may comprise at least one of a Schottky diode, a fast recovery diode, a Zener diode, and a standard rectifier diode. The capacitor element in the present application may comprise at least one of an electrolytic capacitor, a ceramic capacitor, and a thin-film capacitor. The lamp load in the present application may comprise a light-emitting diode (LED).

The power supply used in the present application is an alternating-current power supply, for example, an alternating-current power supply with a rated voltage of 120 V and a rated frequency of 60 Hz. In the present application, the positive electrode of at least one lamp load in each branch may be directly, or indirectly (e.g., via a rectifier circuit such as a rectifier bridge and/or via a constant-current driver chip) connected to the power input end (which is configured to connect to a power supply) of the multiple-way lamp; and the first end of the capacitor element in each branch may be directly, or indirectly (e.g., via a rectifier circuit such as a rectifier bridge and/or via the resistor element) connected to the power input end of the multiple-way lamp.

In the present application, each capacitor element may also be connected in parallel with an additional resistor element, so as to further control a charging and discharging process of the capacitor, thereby improving the circuit response.

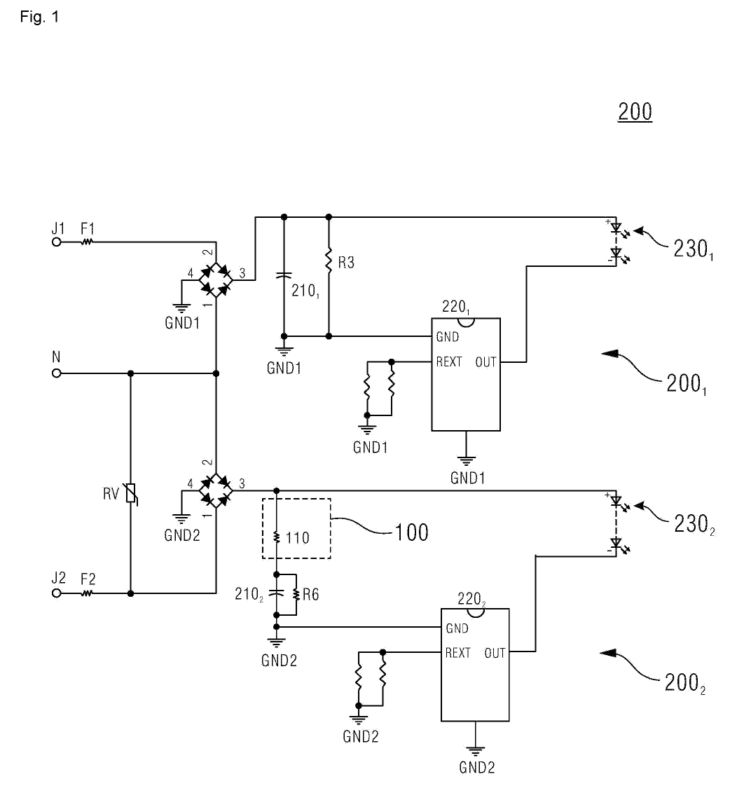

FIG. 1 is a schematic circuit diagram of a power factor correction circuit for a multiple-way lamp and a multiple-way lamp including the power factor correction circuit according to a first embodiment of the present application. The first embodiment shows a situation in which the resistor element of the power factor correction circuit is connected in series on a power supply side of a capacitor element. It should be noted that, to simplify the accompanying drawing, as an example, FIG. 1 shows a situation in which the multiple-way lamp 200 comprises only two branches, i.e. a first branch 2001 and a second branch 2002, and the power factor correction circuit 100 comprises only one resistor element 110, wherein the resistor element 110 is located in the second branch 2002. However, a person of ordinary skill in the art would understand that, in the case of two branches, the resistor element 110 of the power factor correction circuit 100 may also be located in the first branch 2001 instead of the second branch 2002. Alternatively, the power factor correction circuit 100 may comprise two resistor elements, which are located in the first branch 2001 and the second branch 2002, respectively. In addition, the multiple-way lamp 200 can further comprise more branches, and the power factor correction circuit 100 may comprise a resistor element in any at least one branch among the plurality of branches. The multiple-way lamp shown in FIG. 1 can also be referred to as a "three-way lamp", as it has three levels of brightness, which correspond to: only the first branch 2001 is conducted, only the second branch 2002 is conducted, and both the first branch 2001 and the second branch 2002 are conducted, respectively.

As shown in FIG. 1, the first branch 2001 of the multiple-way lamp 200 comprises a capacitor element 2101, a constant-current driver chip 2201 and at least one lamp load 2301, wherein the at least one lamp load 2301 has a positive electrode and a negative electrode, and the positive electrode of the at least one lamp load 2301 is connected to a power input end; the capacitor element 2101 comprises a first end and a second end, the first end of the capacitor element 2101 is connected to the positive electrode of the at least one lamp load 2301 so as to be connected to the power input end, and the second end of the capacitor element 2101 is grounded; and the constant-current driver chip 2201 is connected in series between the ground and the negative electrode of the at least one lamp load 2301. The second branch 2002 of the multiple-way lamp 200 comprises a capacitor element 2102, a constant-current driver chip 2202, and at least one lamp load 2302; and these components are connected in the same manner as in the first branch 2001. In the case where there is no need to distinguish, the capacitor elements2101 and 2102 may be collectively referred to as a capacitor element 210, the constant-current driver chip 2201 and the constant-current driver chip 2202 may be collectively referred to as a constant-current driver chip 220, and the at least one lamp load 2301 and the at least one lamp load2302 may be collectively referred to as at least one lamp load 230. The power factor correction circuit 100 comprises: a resistor element 110, which is located in the second branch 2002 and arranged between the positive electrode of the at least one lamp load 2302 and the first end of the capacitor element 2102.

In the second branch 2002, the resistor element 110 is connected in series on the power supply side (the side closer to the power supply) of the capacitor element 2102, and thus the resistor element 110 can slow down the rising speed and the dropping speed of the charging current of the capacitor element 2102, prolonging the time of the charging current and smoothing a charging current waveform, such that the phase difference between the charging current waveform and voltage waveform is reduced, thereby increasing the power factor of the circuit when the second branch is conducted. Thus, the overall power factor of the multiple-way lamp can be increased in the case of two levels of the multiple-way lamp 200 (when only the second branch is conducted and when both the first branch and the second branch are conducted). Particularly, when both the first branch and the second branch of the multiple-way lamp 200 are conducted, the total power factor of the multiple-way lamp can be increased to 0.7 or higher.

The number of lamp loads in the first branch 2001 and the second branch 2002 may be the same or different. In an exemplary embodiment, the number of at least one lamp load 2301 in the first branch 2001 may be less than the number of at least one lamp load 2302 in the second branch 2002, such that second branch 2002 has a higher load than the first branch 2001. By applying the power factor correction circuit in the second branch with a higher load, compared with applying the power factor correction circuit in the first branch with a lower load, a large increase of power factor can be achieved at a low cost.

Further, the resistor element 110 may comprise a plurality of resistors connected in parallel or in series. The resistance values of the plurality of resistors may be the same or different.

Further, the power factor correction circuit 100 may further comprise another resistor element, which may be located in the first branch 2001 and arranged between the power input end and the first end of the capacitor element 2101 or arranged between the second end of the capacitor element 2101 and the ground.

In the present application, each constant-current driver chip 210 can further comprise an external resistor connecting terminal (as shown by REXT in the drawings), the external resistor connecting terminal is used for being connected to an external resistor, and the resistance value of the external resistor can be used for determining a driving current of the lamp load. Each constant-current driver chip 210 can further comprise a power input terminal, which is connected to a positive input end of a power supply.

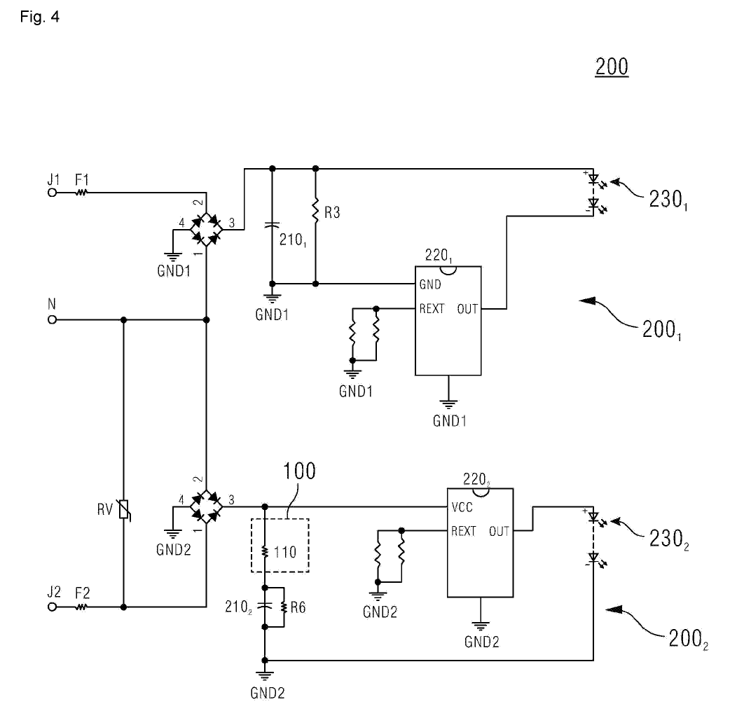

It should be noted that in FIG. 1, in each branch, the negative electrode of the at least one lamp load 230 is connected to an output terminal OUT of a corresponding constant-current driver chip 220, and a grounding terminal GND of the constant-current driver chip 220 is connected to the ground, so that the constant-current driver chip 220 is connected in series between the negative electrode of the at least one lamp load 230 and the ground. However, for any one or more branches, the constant-current driver chip 220 may also be changed to be connected in series between the power input end and the positive electrode of the at least one lamp load 230. This case is shown in FIG. 4. In FIG. 4, the power factor correction circuit is the same as that shown in FIG. 1, but the multiple-way lamp shown in FIG. 4 is different from the multiple-way lamp shown in FIG. 1. Specifically, the only difference between the multiple-way lamp shown in FIG. 4 and that shown in FIG. 1 lies in the fact that, in FIG. 4, in the second branch 2002 of the multiple-way lamp 200, the constant-current driver chip 2202 is connected in series between the power input end and the positive electrode of at least one lamp load 2302. The multiple-way lamp 200 shown in FIG. 4 corresponds to the third embodiment of the present application.

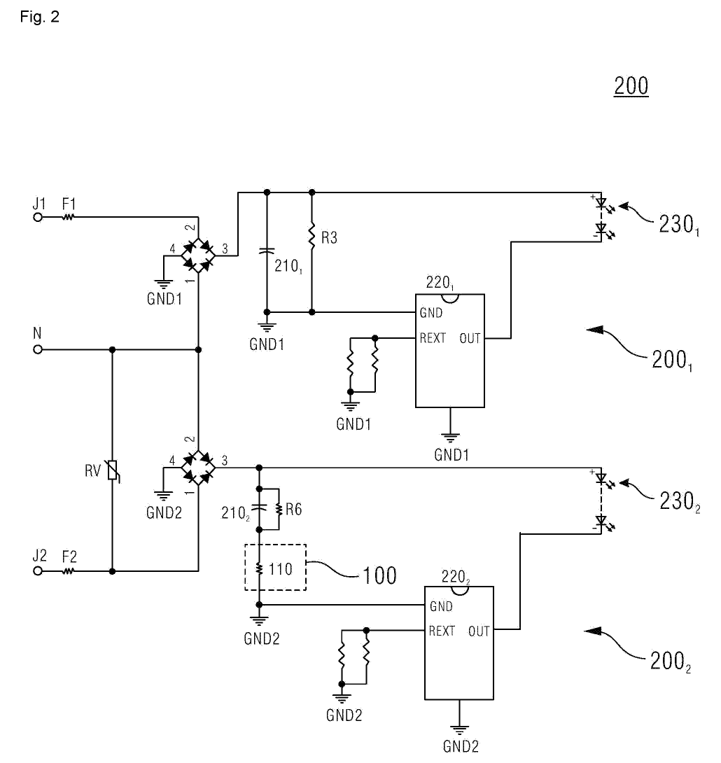

FIG. 2 is another schematic circuit diagram of a power factor correction circuit for a multiple-way lamp and a multiple-way lamp including the power factor correction circuit according to the first embodiment of the present application. FIG. 2 shows a situation in which the power factor correction circuit according to the first embodiment further comprises a diode connected in parallel with the resistor element. Compared with FIG. 1, the power factor correction circuit 100 in FIG. 2 further comprises a diode 120 connected in parallel with the resistor element 110 in the second branch 2002. As shown in FIG. 2, an anode of the diode 120 is connected to the first end of the capacitor element 2102, and a cathode of the diode 120 is connected to the power input end (also connected to the positive electrode of the at least one lamp load 2302 in FIG. 2). Thus, relative to the cathode of the diode 120 connected in parallel with the resistor element 110, the anode of the diode is located at an upstream position in a discharge path of the capacitor element 2102.

As relative to the cathode, the anode of the diode 120 is located at an upstream position in the discharge path of the capacitor element 2102, the forward conduction characteristic of the diode 120 can be utilized. When the capacitor element 2102 is charged via the resistor element 110, the diode 120 is not conducted, and the diode 120 does not affect charging of the capacitor element 2102. However, when the capacitor element 2102 discharges, the diode 120 is conducted due to forward bias, and thus the discharging current of the capacitor element 2102 will flow through the diode 120, but not through the resistor element 110. Thus, power loss caused by discharging of the capacitor element via the resistor element can be reduced, and the energy use efficiency of the circuit can be increased.

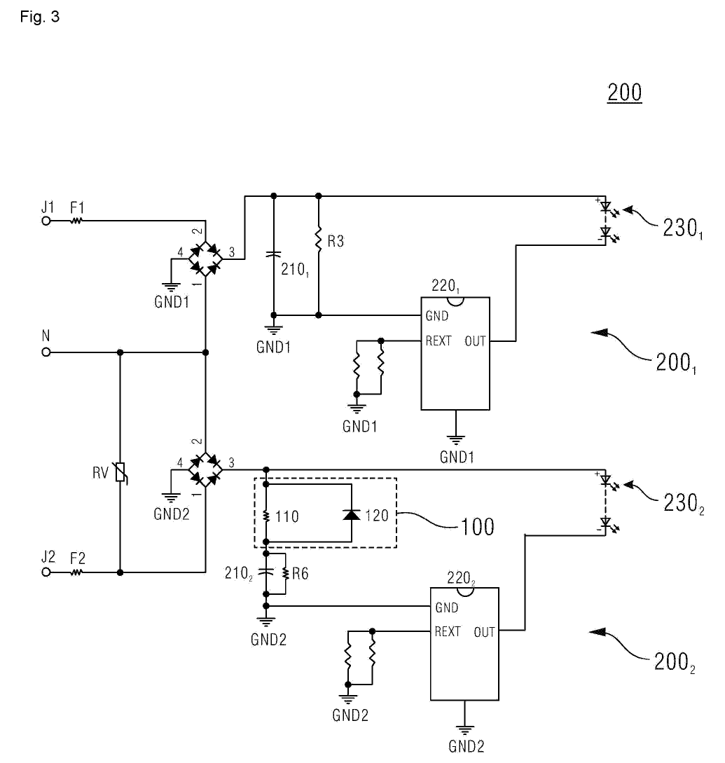

FIG. 3 is a schematic circuit diagram of a power factor correction circuit for a multiple-way lamp and a multiple-way lamp including the power factor correction circuit according to a second embodiment of the present application. The second embodiment shows a situation in which a resistor element of the power factor correction circuit is connected in series on a grounding side rather than a power supply side of a capacitor element. For ease of comparison, except the arranged position of the resistor element 110, the number and connection configuration of components of the multiple-way lamp shown in FIG. 3 are the same as those in FIG. 1. The power factor correction circuit 100 shown in FIG. 3 merely differs from that in FIG. 1 in that: the resistor element 110 in FIG. 3 is arranged between the second end of the capacitor element 2102 in the second branch 2002 and the ground.

By connecting the resistor element 110 in series between the grounding side of the capacitor element and the ground, rather than between the power supply side of the capacitor element and the power input end, the resistor element 110 can also slow down the rising speed and the dropping speed of the charging current of the capacitor element 2102 during charging, thereby prolonging the time of the charging current and smoothing a charging current waveform, such that the phase difference between the charging current waveform and voltage waveform is reduced, thereby increasing the power factor of the circuit when the second branch is conducted.

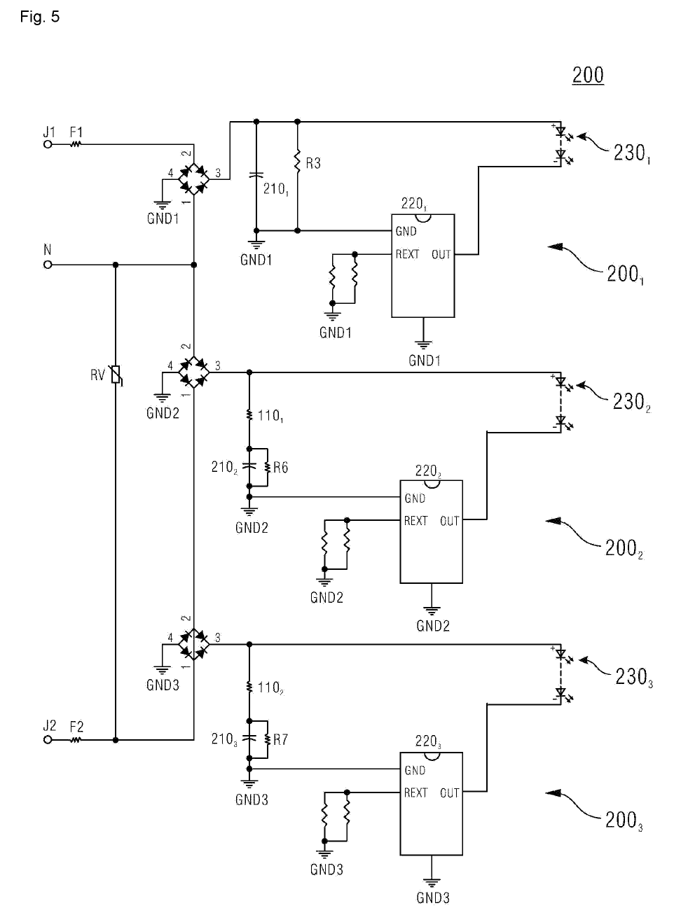

FIG. 1 to FIG. 3 each show a situation in which the power factor correction circuit 100 comprises only one resistor element 110. In cases where the power factor correction circuit 100 comprises a plurality of resistor elements 110 instead of one resistor element 110, the plurality of resistor elements 110 may all be connected in series on the same side (the power supply side or the grounding side) of the capacitor element; or some of the resistor elements 110 may be connected in series on the power supply side of the capacitor element, while other resistor elements 110 are connected in series on the grounding side of the capacitor element. FIG. 5 is a schematic circuit diagram of a power factor correction circuit for a multiple-way lamp and a multiple-way lamp including the power factor correction circuit according to a fourth embodiment of the present application. The multiple-way lamp shown in FIG. 5 merely differs from the multiple-way lamp shown in FIG. 1 in that: the multiple-way lamp 200 in FIG. 5 further comprises a third branch 2003, and the power factor correction circuit 100 is applied to two branches (i.e. the second branch 2002 and the third branch 2003) among the three branches 2001, 2002, and 2003. The number of lamp loads in the three branches differ from one another.

As shown in FIG. 5, the third branch 2003 comprises a capacitor element 2103, a constant-current driver chip 2203, and at least one lamp load 2303. The connection configuration of these components is the same as that of the first branch 2001 and the second branch 2002 shown in FIG. 1, and is not further described herein. The power factor correction circuit 100 comprises a first resister element 1101 and a second resister element 1102; wherein the first resister element 1101 is located in the second branch 2002, and is arranged between the power input end (i.e. the positive electrode of the at least one lamp load 2302) and the first end of the capacitor element 2102, while the second resistor element 1102 is located in the third branch 2003 and is arranged between the power input end (i.e. the positive electrode of the at least one lamp load 2303) and the first end of the capacitor element 2103. In the case where there is no need to distinguish, the first resistor element 1101 and the second resistor element 1102 may be collectively referred to as a resistor element 110.

With the arrangements of the power factor correction circuit 100 and the multiple-way lamp 200 shown in FIG. 5, the total power factor of the multiple-way lamp may also be increased, in particular, the total power factor of the circuit when at least one of the second branch 2002 and the third branch 2003 is conducted.

In an exemplary embodiment, the number of lamp loads in the second branch 2002 and the third branch 2003 can be greater than the number of lamp loads in the first branch 2001. Thus, a large increase of power factor may be achieved at a low cost.

Alternatively, the first resistor element 1101 in the second branch 2002 and/or the second resistor element 1102 in the third branch 2003 may also be arranged between the second end of the corresponding capacitor element and the ground.

Further, a resistor element may be provided in the first branch 200, the resistor element may be arranged between the second end of the capacitor element and the ground or between the power input end and the first end of the capacitor element.

Alternatively, in any one or more branches of the first branch to the third branch, the constant-current driver chip may be connected in series between the power input end and the positive electrode of the at least one lamp load.

Further, the power factor correction circuit 100 can further comprise two diodes (not shown in the figure), wherein the two diodes are connected in parallel with the first resistor element 1101 and the second resistor element 1102, respectively, and an anode of each diode is connected to a first end of a corresponding capacitor, and a cathode of the diode is connected to a positive electrode of a corresponding at least one lamp load.

Hereinabove, exemplary situations of a multiple-way lamp comprising two branches and a multiple-way lamp comprising three branches are described with reference to FIG. 1 to FIG. 5. It is known to a person skilled in the art that a power factor correction circuit comprising at least one resistor element (or an additional diode) can also be applied in at least one branch of a multiple-way lamp comprising more branches.

It should be noted that the terms used herein are for the purpose of describing specific embodiments only and are not intended to limit exemplary embodiments according to the present application. As used herein, the singular form is intended to comprise the plural form as well, unless the context clearly indicates otherwise, and further it should be understood that the terms "comprises" and/or "comprising" when used in the present description, specify the presence of features, steps, operations, devices, assemblies and/or combinations thereof.

It should be noted that the terms "first", "second" etc., in the description, claims, and accompanying drawings of the present application are used to distinguish similar objects, and are not necessarily used to describe a specific sequence or order. It should be understood that the data so used may be interchanged where appropriate so that the embodiments of the present application described herein can be implemented in sequences other than those illustrated or described herein.

The content above merely relates to preferred embodiments of the present application and is not intended to limit the present application. For a person skilled in the art, the present application may have various modifications and variations. Any modifications, equivalent replacements, improvements, etc. made within the spirit and principle of the present application shall all fall within the scope of protection of the present application.

1. A power factor correction circuit for a multiple-way lamp, wherein the multiple-way lamp comprises a plurality of branches, each branch comprising a capacitor element, a constant-current driver chip and at least one lamp load, wherein the at least one lamp load has a positive electrode and a negative electrode, the positive electrode of the at least one lamp load is directly or indirectly connected to a power input end; the capacitor element comprises a first end and a second end, the first end of the capacitor element is connected to the power input end, and the second end of the capacitor element is grounded; the constant-current driver chip is connected in series between the ground and the negative electrode of the at least one lamp load or between the power input end and the positive electrode of the at least one lamp load; the power factor correction circuit is located in at least one branch of the plurality of branches; and the power factor correction circuit comprises:
at least one resistor element, wherein each resistor element is located in a corresponding branch of the at least one branch, and the resistor element is arranged between the power input end and the first end of the capacitor element or between the second end of the capacitor element and the ground.

2. The power factor correction circuit for a multiple-way lamp according to claim 1, wherein the number of lamp loads in the plurality of branches differ from one another.

3. The power factor correction circuit for a multiple-way lamp according to claim 1, wherein the power factor correction circuit further comprises:
at least one diode, wherein each diode is located in a corresponding branch of the at least one branch and is connected in parallel with the resistor element of the branch, and an anode of the diode is located at an upstream position in a discharge path of the capacitor element relative to a cathode of the diode.

4. The power factor correction circuit for a multiple-way lamp according to claim 3, wherein
for any resistor element of the at least one resistor element, when the resistor element is arranged between the power input end and the first end of the capacitor element, the anode of the diode connected in parallel with the resistor element is connected to the first end of the capacitor element, and the cathode of the diode is connected to the power input end.

5. The power factor correction circuit for a multiple-way lamp according to claim 3, wherein
for any resistor element of the at least one resistor element, when the resistor element is arranged between the second end of the capacitor element and the ground, the anode of the diode connected in parallel with the resistor element is connected to the ground, and the cathode of the diode is connected to the second end of the capacitor element.

6. The power factor correction circuit for a multiple-way lamp according to claim 1, wherein the at least one resistor element only comprises one resistor element, and the resistor element is located in a branch, where the number of lamp loads is the greatest, among the plurality of branches.

7. The power factor correction circuit for a multiple-way lamp according to claim 1, wherein each resistor element of the at least one resistor element comprises a plurality of resistors connected in parallel or in series.

8. A multiple-way lamp, comprising:
the power factor correction circuit for a multiple-way lamp according to claim 1; and
a plurality of branches, each branch comprising a capacitor element, a constant-current driver chip and at least one lamp load, wherein the at least one lamp load has a positive electrode and a negative electrode, the positive electrode of the at least one lamp load is directly or indirectly connected to a power input end; the capacitor element comprises a first end and a second end, the first end of the capacitor element is connected to the power input end, and the second end of the capacitor element is grounded; and the constant-current driver chip is connected in series between the ground and the negative electrode of the at least one lamp load or between the power input end and the positive electrode of the at least one lamp load;
wherein at least one resistor element of the power factor correction circuit is located in at least one branch among the plurality of branches, respectively.

9. The multiple-way lamp according to claim 8, wherein for any branch among the plurality of branches, the negative electrode of the at least one lamp load is connected to an output terminal of the constant-current driver chip, and a grounding terminal of the constant-current driver chip is connected to the ground.

10. The multiple-way lamp according to claim 8, wherein for any branch among the plurality of branches, a power input terminal of the constant-current driver chip is connected to the power input end, and an output terminal of the constant-current driver chip is connected to the positive electrode of the at least one lamp load.
